(19) United States
(12) Patent Application Publication
(10) Pub. No.: US 2016/0372272 A1
(43) Pub. Date: Dec. 22, 2016

(54) PHOTOELECTRIC CONVERSION MODULE AND ELECTRONIC DEVICE USING SAME

(71) Applicant: SHARP KABUSHIKI KAISHA, Sakai City, Osaka (JP)

(72) Inventors: Hirokazu ICHINOSE, Sakai City, Osaka (JP); Ryohsuke YAMANAKA, Sakai City, Osaka (JP); Atsushi FUKUI, Sakai City, Osaka (JP); Ryoichi KOMIYA, Sakai City, Osaka (JP); Yuki WATANABE, Sakai City, Osaka (JP)

(21) Appl. No.: 15/123,419

(22) PCT Filed: Dec. 5, 2014
(86) PCT No.: PCT/JP2014/082264

§ 371 Date: Sep. 2, 2016

(30) Foreign Application Priority Data
Mar. 5, 2014 (JP) 2014-042669

(51) Int. Cl. H01G 9/20

(52) U.S. Cl. CPC H01G 9/2081; H01G 9/2031

(57) ABSTRACT

A photoelectric conversion module includes a substrate and a plurality of photoelectric conversion cells connected in series on the substrate and satisfies the relations of the following formulas (I) to (III):

J_{sc}≧20 mA/cm², (I)

I_{sc}/X≦2 mA/cm, and (II)

Pᵢₙ×Rₛ×Y²×10⁻⁴<0.07. (III)

### TECHNICAL FIELD

The present invention relates to a photoelectric conversion module and to an electronic device using the same.

### BACKGROUND ART

For example, PTL 1 discloses a dye-sensitized solar cell module in which a dye-sensitized solar cell and an adjacent dye-sensitized solar cell are connected in series through a connection layer. In PTL 1, it is stated that a significant effect is obtained when the short-circuit current I_{sc} [mA] of one dye-sensitized solar cell and the length X [cm] of a porous semiconductor layer in a direction perpendicular to the series connection direction of the dye-sensitized solar cells satisfy the relation I_{sc} [mA]/X [cm]≧30 [mA/cm] (paragraph [0017] in PTL 1).

In PTL 1, it is also stated that it is preferable that the short-circuit current I_{sc} [mA] of one dye-sensitized solar cell, the resistance value R [Ω] per comb-shaped grid electrode, the ratio η of the area of the porous semiconductor layer in one dye-sensitized solar cell to the area of an aperture of the one dye-sensitized solar cell, and the number n of comb-shaped grid electrodes included in the one dye-sensitized solar cell satisfy the relation 0.001<(½n) I_{sc}·R·η<0.03 (paragraph [0019] in PTL 1). It is stated that, when the relation 0.001<(½n) I_{sc}·R·η<0.03 is satisfied, deterioration in performance due to a voltage drop and deterioration in performance due to a reduction in generated current can be prevented (paragraph [0020] in PTL 1).

### CITATION LIST

### Patent Literature

PTL 1: WO2008/114825

### SUMMARY OF INVENTION

### Technical Problem

The dye-sensitized solar cell module described in PTL 1 is designed under the assumption that a large current, I_{sc} [mA]/X [cm]≧30 [mA/cm], is generated, and no consideration is given to its use under low illuminance.

In the dye-sensitized solar cell module described in PTL 1, since it is necessary to provide the grid electrodes, an increase in cost occurs because of the material and process required for forming the grid electrodes.

In view of the above circumstances, an object of aspects described later is to provide a photoelectric conversion module that has high conversion efficiency even without grid electrodes disposed on a light-receiving surface and can be used under low illuminance and to provide an electronic device using the photoelectric conversion module.

### Solution to Problem

A first aspect of the present invention can provide a photoelectric conversion module including a substrate and a plurality of photoelectric conversion cells connected in series on the substrate. Each of the photoelectric conversion cells includes a first conductive layer, a second conductive layer facing the first conductive layer with a spacing therebetween, a photoelectric conversion layer on the first conductive layer, and a carrier-transport material between the first conductive layer and the second conductive layer. The photoelectric conversion layer includes a porous semiconductor layer and a photosensitizer on the porous semiconductor layer. A short-circuit current density J_{sc} obtained by irradiating the photoelectric conversion cells with pseudo sunlight with an energy density of 100 mW/cm² satisfies the relation of formula (I) (J_{sc}≧20 mA/cm²). A short-circuit current I_{sc} obtained by irradiating the photoelectric conversion cells with pseudo sunlight with an energy density of 1 mW/cm² and a length X of the porous semiconductor layer in a direction perpendicular to a series connection direction of the photoelectric conversion cells satisfy the relation of formula (II) (I_{sc}/X≦2 mA/cm). An intensity Pᵢₙ [mW/cm²] of light incident on the photoelectric conversion module, a total sheet resistance Rₛ [Ω/square] of the first conductive layer and the second conductive layer in the photoelectric conversion cells, and a length Y [cm] of the porous semiconductor layer in the series connection direction of the photoelectric conversion cells satisfy the relation of formula (III) (Pᵢₙ×Rₛ×Y²×10⁻⁴<0.07).

A second aspect of the present invention can provide an electronic device that includes, as a power source unit, the photoelectric conversion module according to the first aspect of the present invention.

### Advantageous Effects of Invention

The above aspects can provide a photoelectric conversion module that has high conversion efficiency even without grid electrodes disposed on a light-receiving surface and can be used under low illuminance and also provide an electronic device using the photoelectric conversion module.

### BRIEF DESCRIPTION OF DRAWINGS

FIG. 1 is a schematic plan view of a photoelectric conversion module in an embodiment.

FIG. 2 is a schematic cross-sectional view of the photoelectric conversion module in the embodiment.

FIG. 3 is a flowchart of an example of a method for producing the photoelectric conversion module in the embodiment.

FIG. 4 is a graph showing the relation among the total sheet resistance Rₛ of first and second conductive layers, the intensity of incident light, and a unit cell width Y, the relation being used to allow a high short-circuit current and suppression of a reduction in FF due to a voltage drop to be achieved simultaneously in the photoelectric conversion module in the embodiment.

FIG. 5 is a graph showing the results of experiments in Experimental Example 2.

### DESCRIPTION OF EMBODIMENTS

An embodiment which is an example of the present invention will next be described. In the drawings used for the description of the embodiment, the same reference numerals represent the same parts or equivalent parts.

### <Structure of Photoelectric Conversion Module>

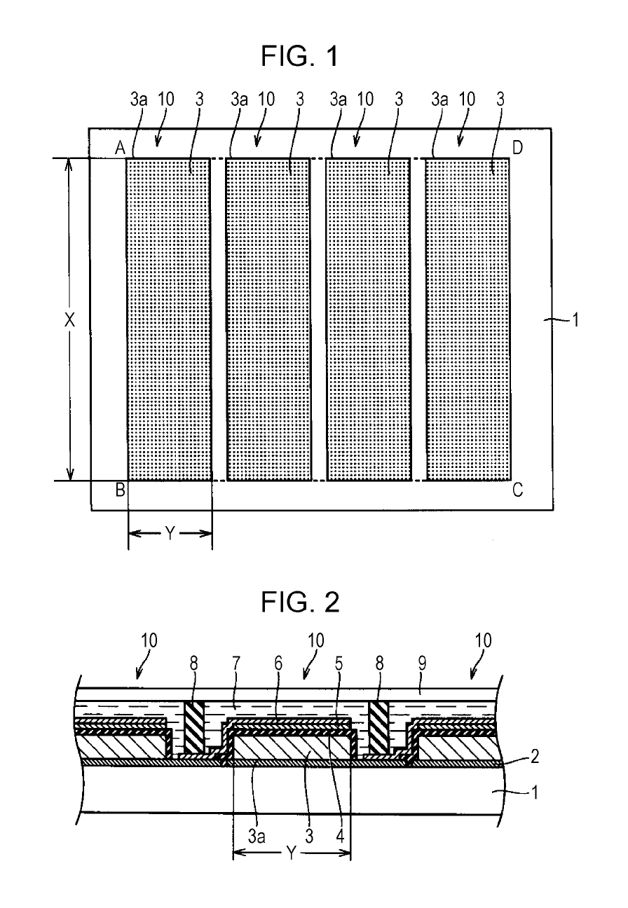

FIG. 1 shows a schematic plan view of a photoelectric conversion module in the embodiment which is an example of the photoelectric conversion module of the present invention. The photoelectric conversion module in the embodiment includes a substrate 1 and a plurality of photoelectric conversion cells 10 connected in series on the substrate 1. The photoelectric conversion cells 10 are connected in series in the horizontal direction in FIG. 1 and each include a photoelectric conversion layer 3 including a porous semiconductor layer 3a.

The length of the porous semiconductor layer 3a in a direction in which the photoelectric conversion cells 10 are connected in series (hereinafter referred to as a “series connection direction”) is Y (the length is hereinafter referred to as a “unit cell width Y”), and the length of the porous semiconductor layer 3a in a direction perpendicular to the series connection direction is X (the length is hereinafter referred to as a “unit cell length X”).

FIG. 2 shows a schematic cross-sectional view of the photoelectric conversion module in the embodiment. The plurality of photoelectric conversion cells 10 included in the photoelectric conversion module in the embodiment are disposed on one substrate 1. The photoelectric conversion cells 10 are separated by a sealing material 8 disposed between the substrate 1 and a cover material 9.

Each of the photoelectric conversion cells 10 includes a first conductive layer 2 on the substrate 1, the photoelectric conversion layer 3 on the first conductive layer 2, a porous insulating layer 4 on the photoelectric conversion layer 3, a catalyst layer 5 on the porous insulating layer 4, a second conductive layer 6 on the catalyst layer 5, and a carrier-transport material 7 that fills a space surrounded by the substrate 1, the cover material 9, and the sealing material 8. The carrier-transport material 7 is also present inside pores of the photoelectric conversion layer 3 on the first conductive layer 2, pores of the porous insulating layer 4, pores of the catalyst layer 5, and pores of the second conductive layer 6.

### <Substrate>

The substrate 1 used may be a light-transmitting substrate allowing light to pass therethrough. However, it is only necessary that the substrate 1 be formed of a material that substantially transmits at least light with a wavelength to which a sensitizing dye described later has effective sensitivity. The substrate 1 does not necessarily allow light over the entire wavelength range to transmit therethrough. The substrate 1 has a thickness of preferably from 0.2 mm to 5 mm inclusive.

No particular limitation is imposed on the material forming the substrate 1, so long as the material can generally be used for solar cells and allows the effects of the invention to be achieved. The material used may be, for example, a glass substrate such as a soda-lime glass, fused quartz glass, or crystalline quartz glass substrate or a heat resistant resin sheet such as a flexible film.

The flexible film used may be a film of, for example, tetraacetylcellulose (TAC), polyethylene terephthalate (PET), polyphenylene sulfide (PPS), polycarbonate (PC), polyarylate (PA), polyetherimide (PEI), a phenoxy resin, or Teflon (registered trademark).

When a component is formed on the substrate 1, the substrate 1 may be heated. For example, when the substrate 1 is heated to about 250° C. to form the porous semiconductor layer 3a on the substrate 1, it is preferable to use, as the material of the substrate 1, a material having heat resistance at 250° C. or higher such as Teflon (registered trademark).

The substrate 1 can be used also as a base when the photoelectric conversion cells 10 are attached to another structure. In this case, the periphery of the substrate 1 may be connected to the structure using a fastening member such as a screw through a metal-made component.

### <First Conductive Layer>

No particular limitation is imposed on the first conductive layer 2, so long as it has electric conductivity and light-transmitting properties. For example, at least one selected from the group consisting of indium tin oxide (ITO), tin oxide (SnO₂), fluorine-doped tin oxide (FTO), and zinc oxide (ZnO) can be used.

The first conductive layer 2 has a thickness of preferably from 0.02 μm to 5 μm inclusive. The electrical resistance of the first conductive layer 2 is preferably as low as possible and is preferably 40 Ω/square or less.

### <Photoelectric Conversion Layer>

The photoelectric conversion layer 3 includes the porous semiconductor layer 3a and a photosensitizer on the porous semiconductor layer 3a. In the present embodiment, a description will be given of the case in which a sensitizing dye is used as the photosensitizer. However, instead of the sensitizing dye, quantum dots, for example, may be used as the photosensitizer.

### <Porous Semiconductor Layer>

No particular limitation is imposed on the material of the porous semiconductor layer 3a, so long as it is generally used as a photoelectric conversion material. The material used may be, for example, at least one selected from the group consisting of titanium oxide, zinc oxide, tin oxide, iron oxide, niobium oxide, cerium oxide, tungsten oxide, barium titanate, strontium titanate, cadmium sulfide, lead sulfide, zinc sulfide, indium phosphide, copper-indium sulfide (CuInS₂), CuAlO₂, and SrCu₂O₂. Of these, titanium oxide is preferred because of its high stability.

The titanium oxide used for the porous semiconductor layer 3a may be, for example, titanium hydroxide, hydrous titanium oxide, or any of various titanium oxides in a narrow sense such as anatase-type titanium oxide, rutile-type titanium oxide, amorphous titanium oxide, metatitanic acid, and orthotitanic acid. These may be used alone or as a mixture. Crystalline titanium oxide may have any of the two crystalline structures of the anatase and rutile types, and this depends on its production method and thermal history. Generally, the crystalline titanium oxide is of the anatase type. From the viewpoint of dye sensitization, the titanium oxide used is preferably a titanium oxide with high anatase content, e.g., a titanium oxide with an anatase content of 80% or more.

The semiconductor may be in either a single crystalline form or a polycrystalline form. From the viewpoint of stability, the ease of crystal growth, production cost, etc., the semiconductor is preferably polycrystalline, and nanoscale or microscale fine polycrystalline semiconductor particles are used preferably. Therefore, fine titanium oxide particles are preferably used as the raw material of the porous semiconductor layer 3a.

The fine titanium oxide particles can be produced by a method such as a liquid phase method, e.g., hydrothermal synthesis or a sulfuric acid method, or a vapor phase method. The fine titanium oxide particles can also be produced by high temperature hydrolysis of a chloride, which is developed by Degussa.

The fine semiconductor particles may be a mixture of fine semiconductor compound particles of the same type or different types that have at least two different diameters. Fine semiconductor particles with a larger diameter scatter incident light and may contribute to improvement in light-harvesting efficiency, and fine semiconductor particles with a smaller diameter provide an increased number of adsorption sites and may contribute to improvement in the adsorption amount of the sensitizing dye.

When fine semiconductor particles composed of a mixture of fine particles with different diameters are used, the ratio of the average diameters of the fine particles is preferably 10 or more. The average diameter of large-diameter fine particles may be, for example, from 100 nm to 500 nm inclusive. The average diameter of small-diameter fine particles may be, for example, from 5 nm to 50 nm inclusive. When fine semiconductor particles composed of a mixture of different semiconductor compounds are used, it is effective that particles of a semiconductor compound with a stronger adsorption action are reduced in diameter.

No particular limitation is imposed on the thickness of the porous semiconductor layer 3a, and the thickness may be, for example, from 0.1 μm to 100 μm inclusive. The surface area of the porous semiconductor layer 3a is preferably from 10 m²/g to 200 m²/g inclusive.

### <Photosensitizer>

For example, a sensitizing dye may be used as the photosensitizer placed on the porous semiconductor layer 3a. One or at least two of various organic dyes and metal complex dyes that absorb light in the visible range or the infrared range may be selectively used as the sensitizing dye.

The organic dye used may be, for example, at least one selected from the group consisting of azo-based dyes, quinone-based dyes, quinonimine-based dyes, quinacridone-based dyes, squarylium-based dyes, cyanine-based dyes, merocyanine-based dyes, triphenylmethane-based dyes, xanthene-based dyes, porphyrin-based dyes, perylene-based dyes, indigo-based dyes, and naphthalocyanine-based dyes. Generally, the absorption coefficient of an organic dye is larger than the absorption coefficient of a metal complex dye having a form in which a molecule is coordinated to a transition metal.

A metal complex dye includes a metal and a molecule coordinated thereto. Examples of the molecule include porphyrin-based dyes, phthalocyanine-based dyes, naphthalocyanine-based dyes, and ruthenium-based dyes. The metal may be, for example, at least one selected from the group consisting of Cu, Ni, Fe, Co, V, Sn, Si, Ti, Ge, Cr, Zn, Ru, Mg, Al, Pb, Mn, In, Mo, Y, Zr, Nb, Sb, La, W, Pt, TA, Ir, Pd, Os, Ga, Tb, Eu, Rb, Bi, Se, As, Sc, Ag, Cd, Hf, Re, Au, Ac, Tc, Te, and Rh. Particularly, the metal complex dye used is preferably a dye in which a metal is coordinated to a phthalocyanine-based dye or a ruthenium-based dye and is particularly preferably a ruthenium-based metal complex dye.

The ruthenium-based metal complex dye used may be one of commercial ruthenium-based metal complex dyes such as Ruthenium 535 dye, Ruthenium 535-bis TBA dye, and Ruthenium 620-1H3 TBA dye which are trade names and manufactured by Solaronix.

### <Porous Insulating Layer>

At least one selected from the group consisting of titanium oxide, niobium oxide, zirconium oxide, silicon oxides such as silica glass and soda-lime glass, aluminum oxide, and barium titanate may be used for the porous insulating layer 4.

Particularly, rutile-type titanium oxide is preferably used for the porous insulating layer 4. When rutile-type titanium oxide is used for the porous insulating layer 4, the average particle diameter of the rutile-type titanium oxide is preferably from 5 nm to 500 nm inclusive and more preferably from 10 nm to 300 nm inclusive.

### <Catalyst Layer>

At least one selected from the group consisting of platinum, carbon black, Ketjen black, carbon nanotubes, and fullerenes may be used for the catalyst layer 5.

### <Second Conductive Layer>

The second conductive layer 6 may be formed of the same material as the material of the first conductive layer 2 or may be formed of a non-light-transmitting material. For example, a metal material containing at least one selected from the group consisting of titanium, tungsten, gold, silver, copper, aluminum, and nickel may be used for the second conductive layer 6.

The thickness of the second conductive layer 6 is preferably from 0.02 μm to 5 μm inclusive. The electric resistance of the second conductive layer 6 is preferably as low as possible and is preferably 40 Ω/square or less.

### <Sealing Material>

The sealing material 8 used may be, for example, a material containing at least one selected from the group consisting of silicone resins, epoxy resins, polyisobutylene-based resins, hot-melt resins, and glass-based materials such as glass frits. More specifically, type 31X-101 manufactured by ThreeBond Co., Ltd., type 31X-088 manufactured by ThreeBond Co., Ltd., general commercial epoxy resins, etc. can be used.

### <Cover Material>

The cover material 9 used may be any material that can seal the carrier-transport material 7 and can prevent penetration of water etc. from the outside. When the photoelectric conversion module is installed outdoors, it is preferable that the cover material 9 used is, for example, a material having high mechanical strength such as tempered glass.

### <Carrier-Transport Material>

The carrier-transport material 7 used is preferably a liquid electrolyte such as an electrolytic solution. Instead of the liquid electrolyte, for example, a solid electrolyte, a gel electrolyte, or a molten-salt gel electrolyte may be used.

No particular limitation is imposed on the liquid electrolyte, so long as it is a liquid containing a redox species and can be used for general cells, solar cells, etc. Specifically, the liquid electrolyte used may be an electrolyte composed of a redox species and a solvent that can dissolve the redox species, an electrolyte composed of a redox species and a molten salt that can dissolve the redox species, or an electrolyte composed of a redox species and a combination of a solvent and a molten salt that can dissolve the redox species.

The redox species used may be, for example, an I⁻/I³⁻-based, Br²⁻/Br³⁻-based, Fe₂₊/Fe³⁺-based, or quinone/hydroquinone-based redox species. More specifically, the redox species used may be a combination of iodine (I₂) and a metal iodide such as lithium iodide (LiI), sodium iodide (NaI), potassium iodide (KI), or calcium iodide (CaI₂). A combination of iodine and a tetraalkyl ammonium salt such as tetraethylammonium iodide (TEAI), tetrapropylammonium iodide (TPAI), tetrabutylammonium iodide (TBAI), or tetrahexylammonium iodide (THAI) may also be used. A combination of bromine and a metal bromide such as lithium bromide (LiBr), sodium bromide (NaBr), potassium bromide (KBr), or calcium bromide (CaBr₂) may also be used. Of these, a combination of LiI and I₂ is particularly preferable as the redox species.

Preferably, the solvent used for the redox species is, for example, a solvent containing at least one selected from the group consisting of carbonate compounds such as propylene carbonate, nitrile compounds such as acetonitrile, alcohols such as ethanol, water, and aprotic polar materials. More preferably, a carbonate compound or a nitrile compound is used alone, or a mixture thereof is used.

Any solid electrolyte may be used, so long as it is a conductive material capable of transporting electrons, holes, or ions, usable as an electrolyte of a solar cell, and having no flowability. Examples of the solid electrolyte that can be used include: hole transport materials such as polycarbazole; electron transport materials such as tetranitrofluorenone; conductive polymers such as polylol; polyelectrolytes prepared by solidifying liquid electrolytes with macromolecular compounds; p-type semiconductors such as copper iodide and copper thiocyanate; and electrolytes prepared by solidifying liquid electrolytes containing molten salts with fine particles.

Generally, the gel electrolyte is composed of an electrolyte and a gelling agent. Examples of the gelling agent that can be used include macromolecular gelling agents such as cross-linked polyacrylic resin derivatives, cross-linked polyacrylonitrile derivatives, polyalkylene oxide derivatives, silicone resins, and polymers having a nitrogen-containing heterocyclic quaternary compound salt structure in their side chain.

Generally, the molten-salt gel electrolyte is composed of the above gel electrolyte and an ambient temperature molten salt. Examples of the ambient temperature molten salt that can be used include nitrogen-containing heterocyclic quaternary ammonium salt compounds such as pyridinium salts and imidazolium salts.

If necessary, an additive may be added to the above electrolyte. Examples of the additive that can be used include: nitrogen-containing aromatic compounds such as t-butylpyridine (TBP); and imidazole salts such as dimethylpropylimidazole iodide (DMPII), methylpropylimidazole iodide (MPII), ethylmethylimidazole iodide (EMII), ethylimidazole iodide (EII), and hexylmethylimidazole iodide (HMII), and these additives may be used alone or as a mixture of two or more.

The electrolyte concentration in the electrolyte is preferably from 0.001 mol/L to 1.5 mol/L inclusive and more preferably from 0.01 mol/L to 0.7 mol/L inclusive.

### <Method of Producing Photoelectric Conversion Module>

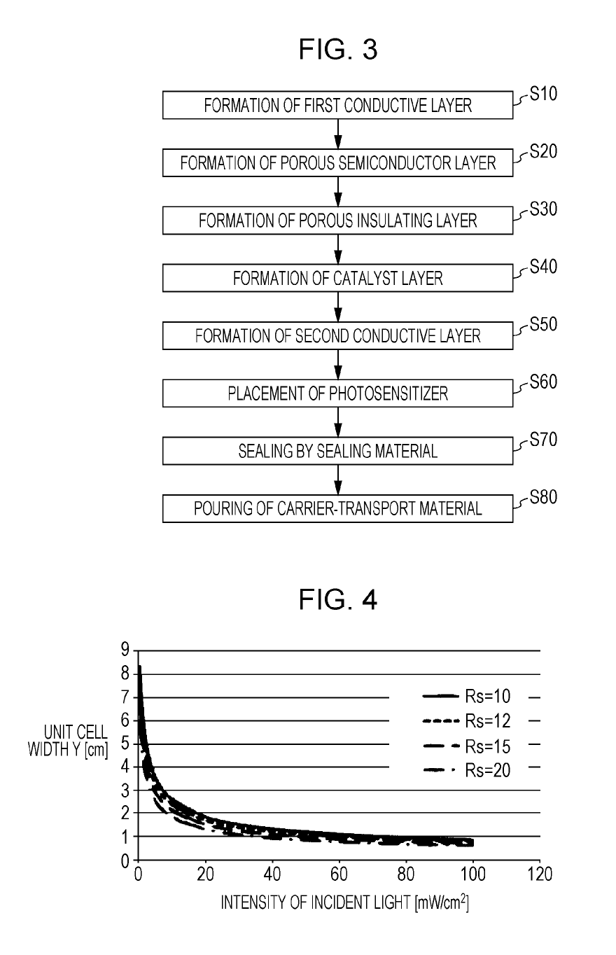

FIG. 3 shows a flowchart of an example of a method of producing the photoelectric conversion module in the embodiment. As shown in FIG. 3, the method of producing the photoelectric conversion module in the embodiment includes a first conductive layer forming step (S10), a porous semiconductor layer forming step (S20), a porous insulating layer forming step (S30), a catalyst layer forming step (S40), a second conductive layer forming step (S50), a photosensitizer placing step (S60), a sealing step (S70) with a sealing material, and a carrier-transport material pouring step (S80). It will be appreciated that the method of producing the photoelectric conversion module in the embodiment includes steps other than S10 to S80.

### <First Conductive Layer Forming Step>

The first conductive layer forming step (S10) can be performed by forming the first conductive layer 2 on the substrate 1. To form the first conductive layer 2, a method such as a sputtering method or a spraying method may be used.

### <Porous Semiconductor Layer Forming Step>

The porous semiconductor layer forming step (S20) can be performed by forming the porous semiconductor layer 3a on the first conductive layer 2. No particular limitation is imposed on the method of forming the porous semiconductor layer 3a, and any conventionally known method may be used. For example, a suspension containing the above-described fine semiconductor particles is applied to the first conductive layer 2, and at least one of drying and firing is performed, whereby the porous semiconductor layer 3a can be formed.

More specifically, first, the fine semiconductor particles are dispersed in an appropriate solvent to obtain a suspension. Examples of the solvent that can be used include: glyme-based solvents such as ethylene glycol monomethyl ether; alcohols such as isopropyl alcohol; alcohol-based solvent mixtures such as isopropyl alcohol/toluene; and water. Instead of the suspension, a commercial titanium oxide paste (e.g., Ti-nanoxide, T, D, T/SP, D/SP manufactured by Solaronix) may be used.

Next, the suspension obtained as described above is applied to the first conductive layer 2 and subjected to at least one of drying and firing, whereby the porous semiconductor layer 3a can be formed. To apply the suspension, a method such as a doctor blade method, a squeegee method, a spin coating method, or a screen printing method may be used.

The conditions of drying and firing of the suspension, such as temperature, time, and atmosphere, may be appropriately set according to the type of the fine semiconductor particles. For example, the suspension can be dried and fired by holding it in an air atmosphere or an inert gas atmosphere in a temperature range of from 50° C. to 800° C. inclusive for 10 seconds or longer and 12 hours or shorter. The suspension may be dried and fired once at a single temperature or twice or more at different temperatures.

The porous semiconductor layer 3a may have a layered structure. When the porous semiconductor layer 3a has a layered structure, suspensions of fine semiconductor particles of different types are prepared. Then each of these suspensions is applied and subjected to at least one of drying and firing, whereby the porous semiconductor layer 3a can be formed.

After the porous semiconductor layer 3a is formed, aftertreatment may be performed for the purpose of improving performance such as improvement in electric connection between the fine semiconductor particles, an increase in the surface area of the porous semiconductor layer 3a, and a reduction in defect levels in the fine semiconductor particles. For example, when the porous semiconductor layer 3a is formed of titanium oxide, the performance of the porous semiconductor layer 3a can be improved by subjecting it to aftertreatment using an aqueous titanium tetrachloride solution.

### <Porous Insulating Layer Forming Step>

The porous insulating layer forming step (S30) can be performed by forming the porous insulating layer 4 on the photoelectric conversion layer 3. No particular limitation is imposed on the method of forming the porous insulating layer 4, and the porous insulating layer 4 can be formed using a method similar to the above-described method of forming the porous semiconductor layer 3a. For example, an insulating material in the form of fine particles is dispersed in a solvent and mixed with a macromolecular compound such as ethyl cellulose or polyethylene glycol (PEG) to produce a paste. The paste is applied to the surface of the photoelectric conversion layer 3 and subjected to at least one of drying and firing to thereby perform the porous insulating layer forming step.

### <Catalyst Layer Forming Step>

The catalyst layer forming step (S40) can be performed by forming the catalyst layer 5 on the porous insulating layer 4. No particular limitation is imposed on the method of forming the catalyst layer 5, and any conventionally known method can be used. When platinum is used for the catalyst layer 5, a method such as a sputtering method, thermal decomposition of chloroplatinic acid, or electrodeposition may be used to form the catalyst layer 5. When carbon such as carbon black, Ketjen black, carbon nanotubes, or fullerenes is used for the catalyst layer 5, a method such as application of a paste prepared by dispersing the carbon in a solvent to the porous insulating layer 4 using, for example, a screen printing method can be used to form the catalyst layer 5.

### <Second Conductive Layer Forming Step>

The second conductive layer forming step (S50) can be performed by forming the second conductive layer 6 so as to cover the catalyst layer 5, the porous insulating layer 6, and the first conductive layer 2. To form the second conductive layer 6, a method such as a sputtering method or a spraying method can be used.

### <Photosensitizer Placing Step>

The photosensitizer placing step (S60) can be performed, for example, by adsorbing the sensitizing dye to the porous semiconductor layer 3a. In this manner, a photoelectric conversion layer 3 in which the sensitizing dye is adsorbed to the porous semiconductor layer 3a can be formed on the first conductive layer 2.

To allow the sensitizing dye to strongly adsorb to the porous semiconductor layer 3a, it is preferable that the sensitizing dye used has, in its molecule, an interlocking group such as a carboxyl group, an alkoxy group, a hydroxyl group, a sulfonic acid group, an ester group, a mercapto group, or a phosphonyl group. Generally, the interlocking group is a functional group which, when the sensitizing dye is fixed to the porous semiconductor layer 3a, is interposed therebetween and provides electrical connection that facilitates electron transfer between the photosensitizer in an excited state and the conduction band of the semiconductor.

To adsorb the sensitizing dye to the porous semiconductor layer 3a, a method such as immersion of the porous semiconductor layer 3a in a dye adsorption solution containing the sensitizing dye dissolved therein can be used. When the porous semiconductor layer 3a is immersed in the dye adsorption solution containing the sensitizing dye dissolved therein, the dye adsorption solution may be heated in order to allow the dye adsorption solution to penetrate deep into the pores of the porous semiconductor layer 3a.

The solvent used to dissolve the sensitizing dye may be any solvent that can dissolve the sensitizing dye, and, for example, at least one selected from the group consisting of alcohols, toluene, acetonitrile, tetrahydrofuran (THF), chloroform, and dimethylformamide may be used. It is preferable that the solvent used to dissolve the sensitizing dye is purified, and a mixture of two or more solvents may also be used.

The concentration of the sensitizing dye in the dye adsorption solution may be appropriately set according to the types of the sensitizing dye and solvent used and the conditions of the adsorption process. To improve the adsorption capability, it is preferable that the concentration of the dye adsorption solution is high, and the concentration is preferably, for example, 1×10⁻⁵ mol/L or more. When the dye adsorption solution is prepared, the dye adsorption solution may be heated in order to improve the solubility of the sensitizing dye.

<Sealing Step with Sealing Material>

The sealing step (S70) with the sealing material can be performed by joining the substrate 1 to the cover material 9 using the sealing material 8. The sealing step (S70) with the sealing material 8 may be performed, for example, by applying the sealing material 8 to the cover material 9 using a dispenser, then laminating the substrate 1 to the cover material 9, and curing the sealing material 8.

### <Carrier-Transport Material Pouring Step>

The carrier-transport material pouring step (S80) can be performed by pouring the carrier-transport material 7 into spaces between the substrate 1 and the cover material 9 and separated by the sealing material 8. The carrier-transport material pouring step (S80) may be performed, for example, by pouring the carrier-transport material 7 from holes formed in advance in the sealing material 8. The photoelectric conversion module in the embodiment can be produced in the manner described above.

### <Operational Advantages>

The photoelectric conversion module in the embodiment is characterized in that a short-circuit current density J_{sc} obtained by irradiating the photoelectric conversion cells 10 with pseudo sunlight with an energy density of 100 mW/cm² satisfies the relation of formula (I) (J_{sc}≧20 mA/cm²), that the unit cell length X and a short-circuit current I_{sc} obtained by irradiating the photoelectric conversion cells 10 with pseudo sunlight with an energy density of 1 mW/cm² satisfy the relation of formula (II) (I_{sc}/X≦2 mA/cm), and that the intensity Pᵢₙ [mW/cm²] of light incident on the photoelectric conversion module, the total sheet resistance Rₛ [Ω/square] of the first conductive layer 2 and the second conductive layer 6 in the photoelectric conversion cells 10, and the unit cell width Y [cm] satisfy the relation of formula (III) (Pᵢₙ×Rₛ×Y²×10⁻⁴<0.07). Therefore, the photoelectric conversion module in the embodiment has high conversion efficiency without gird electrodes disposed on the light-receiving surface and can be used even under low illuminance. Since the photoelectric conversion module in the embodiment has no grid electrodes, an effective power generation area that contributes power generation (a light-receiving area fraction) can be increased, and the cost of the material of the grid electrodes and their installation cost can be reduced. The reason that formula (II) above is satisfied is that, when I_{sc}/X>2 mA/cm, the characteristics of the photoelectric conversion module may deteriorate when the unit cell width Y is increased.

The conventional dye-sensitized solar cell module is not designed so as to be suitable for low illuminance. Specifically, the conventional dye-sensitized solar cell module is basically designed under the assumption that it is irradiated with strong light of, for example, 1 sun (100 mW/cm²). In the conventional dye-sensitized solar cell module, grid electrode portions are provided on the light-receiving surface in order to reduce the sheet resistance of a light-transmitting substrate including a transparent conductive layer, so that the light-receiving area fraction is small. Therefore, the conventional dye-sensitized solar cell module can generate only a small current under low illuminance and is not suitable as a dye-sensitized solar cell module for low illuminance.

Let the short-circuit current of one of the photoelectric conversion cells 10 (hereinafter referred to as a “unit cell”) be I_{sc}, and the total resistance of the first conductive layer 2 and the second conductive layer 6 in the unit cell be R. Then the voltage drop E of the unit cell can be represented by formula (A) below.

E=(½)·I_{sc}·R (A)

The short-circuit current density J_{sc} [mA/cm²] of the unit cell can be changed by changing the type of sensitizing dye used as the photosensitizer. Therefore, to ensure the short-circuit current I_{sc} of the unit cell, the sensitizing dye used is selected such that the short-circuit current density J_{sc} [mA/cm²] when the unit cell is irradiated with pseudo sunlight with an energy density of 100 mW/cm² satisfies formula (B) below.

J_{sc}≧20 [mA/cm²] (B)

It has been experimentally found that the intensity Pᵢₙ [mW/cm²] of light incident on the photoelectric conversion module is approximately proportional to the short-circuit current density J_{sc} [mA/cm²] of the unit cell. When the sensitizing dye used allows formula (B) above to be satisfied, the following formula (C) holds.

J_{sc}≧0.2Pᵢₙ (C)

The total resistance R of the first conductive layer 2 and the second conductive layer 6 in the unit cell is represented by the following formula (D) using the unit cell width Y [cm] and the total sheet resistance Rₛ [Ω/square] of the first conductive layer 2 and the second conductive layer 6 in the unit cell.

R=Rₛ·Y (D)

Therefore, the short-circuit current I_{sc} of the unit cell and the short-circuit current density J_{sc} [mA/cm²] of the unit cell satisfy the relation of formula (E) below.

I_{sc}=J_{sc}·Y≧0.2Pᵢₙ·Y (E)

From the above formulas (A), (D), and (E), the relation of formula (F) below holds.

E≧((½)·0.2Pᵢₙ˜Rₛ·Y²)/1000=(Pᵢₙ·Rₛ·Y²)/10000 (F)

It has been experimentally found that, when the relation E<0.07 holds, a FF of 0.65 or more can be ensured. Therefore, to ensure a FF of 0.65 or more in connection with formula (F), it is necessary that the relation of formula (G) below hold.

((Pᵢₙ·Rₛ·Y²)/10000)<0.07 (G)

Therefore, when the unit cell width Y [cm] is determined from the intensity Pᵢₙ [mW/cm²] of light incident on the photoelectric conversion module and the total sheet resistance Rₛ [Ω/square] of the first conductive layer 2 and the second conductive layer 6 in the unit cell such that the relation represented by formula (H) below, which is a modification of formula (G) above, is satisfied, the short-circuit current I_{sc} of the unit cell can be increased while a reduction in FF is suppressed.

Y²<700/(Pᵢₙ·Rₛ) (H)

For example, when Pᵢₙ=1 [mW/cm²] and Rₛ=12 [Ω/square], the unit cell width Y is less than 7.63 [cm] in order to satisfy formula (H) above.

The total sheet resistance Rₛ (10 [Ω/square], 12 [Ω/square], 15 [Ω/square], or 20 [Ω/square]) of the first conductive layer 2 and the second conductive layer 6 in the photoelectric conversion cells 10 included in the photoelectric conversion module in the embodiment and various values of the intensity Pᵢₙ [mW/cm²] of the incident light were substituted into formula (H) above, and the obtained values of the unit cell width Y [cm] were plotted. The results are shown in FIG. 4. In FIG. 4, the horizontal axis represents the intensity [mW/cm²] of the incident light, and the vertical axis represents the unit cell width Y [cm].

Particularly, when the photoelectric conversion module in the embodiment is used under low illuminance, the amount of current generated per unit cell is small, so that the second conductive layer 6 can be reduced in thickness. For example, when the second conductive layer 6 contains titanium (Ti), the thickness of the second conductive layer 6 is preferably from 0.3 μm to 2 μm inclusive. When the thickness of the second conductive layer 6 containing Ti is 0.3 μm or more, the conversion efficiency of the photoelectric conversion module can be high even under low illuminance at an energy density of, for example, 1 mW/cm². When the thickness of the second conductive layer 6 containing Ti is 2 μm or less, the effect of suppressing delamination of the second conductive layer 6 can be improved, so that the yield of the photoelectric conversion module can be improved. From the viewpoint of maintaining high conversion efficiency even under low illuminance and further improving the effect of suppressing the delamination of the second conductive layer 6, the thickness of the second conductive layer 6 containing Ti is more preferably from 0.3 μm to 1 μm inclusive.

Even when the total sheet resistance Rₛ of the first conductive layer 2 and the second conductive layer 6 is increased, for example, from 12 [Ω/square] to 15 [Ω/square] as a result of reducing the thickness of the second conductive layer 6, the maximum unit cell width Y at Pᵢₙ=1 [mW/cm²] decreases only from 7.63 [cm] to 6.83 [cm].

The total sheet resistance Rₛ of the first conductive layer 2 and the second conductive layer 6 in a unit cell is preferably 20 [Ω/square] or less. When the total sheet resistance Rₛ of the first conductive layer 2 and the second conductive layer 6 in the unit cell is 20 [Ω/square] or less, a reduction in FF due to a voltage drop can be suppressed, and the conversion efficiency can thereby be improved.

### Experimental Example 1

### Example 1

A photoelectric conversion module in Example 1 having the structure shown in FIGS. 1 and 2 was produced.

### (Formation of First Conductive Layer)

First, a glass substrate with an SnO₂ film, having a surface with dimensions of 120 mm length×420 mm width, and manufactured by Nippon Sheet Glass Co., Ltd. was prepared. Then, as shown in FIG. 1, portions of the SnO₂ film extending linearly in a direction perpendicular to the series connection direction and spaced at intervals of the unit cell width Y+1 mm were removed by a laser scribing method. In this manner, stripe-shaped scribed lines from which the SnO₂ film had been removed were formed, and the SnO₂ film serving as the first conductive layer 2 was thereby shaped into strips on the glass substrate serving as the substrate 1.

Next, a screen printing machine (LS-34TVA manufactured by NEWLONG SEIMITSU KOGYO Co., Ltd.) was used to apply a commercial titanium oxide paste (trade name: Ti-Nanoxide D/SP manufactured by Solaronix, average particle diameter: 13 nm) to the strips of the SnO₂ film positioned between the scribed lines to thereby form a pattern in which four unit cells having a unit cell width Y shown in Table 1 were arranged at 1 mm intervals.

### (Formation of Porous Semiconductor Layer)

Then the titanium oxide paste was left at room temperature for 1 hour for leveling to thereby obtain a coating, and the coating was subjected to preliminary drying at 80° C. for 20 minutes and then fired at 450° C. for 1 hour. The titanium oxide paste applying step, the leveling step, the preliminary drying step, and the firing step were repeated in this order to form a 30 μm-thick porous semiconductor layer 3a formed of the titanium oxide.

### (Adsorption of Sensitizing Dye)

Ruthenium 620-1H3TBA dye (manufactured by Solaronix) represented by structural formula (i) below was used as the sensitizing dye to prepare a solution of the sensitizing dye in a 1:1 mixture of acetonitrile (manufactured by Aldrich Chemical Company)/t-butyl alcohol (manufactured by Aldrich Chemical Company) (sensitizing dye concentration: 4×10⁻⁴ mol/L). The porous semiconductor layer 3a was immersed in the prepared solution and left to stand under the temperature condition of 40° C. for 20 hours. Then the porous semiconductor layer 3a was washed with ethanol (manufactured by Aldrich Chemical Company) and dried. By adsorbing the dye to the porous semiconductor layer 3a in the manner described above, the photoelectric conversion layer 3 was formed on the first conductive layer 2. In structural formula (i), “TBA” stands for tetrabutylammonium.

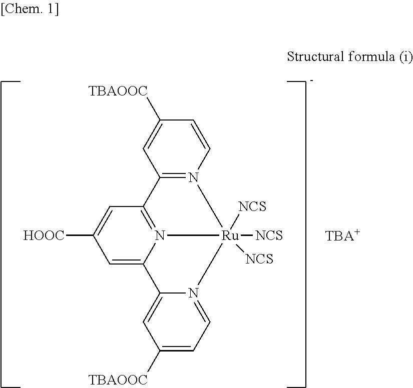

### (Formation of Porous Insulating Layer)

A paste containing fine zirconium oxide particles with a diameter of 100 nm (manufactured by C.I. Kasei Co., Ltd.) was prepared by the same method as described above. The screen printing plate and screen printing machine (LS-34TVA manufactured by NEWLONG SEIMITSU KOGYO Co., Ltd.) used to produce the porous semiconductor layer 3a were used to apply the prepared paste to the photoelectric conversion layer 3. The paste was left at room temperature for 1 hour for leveling, then subjected to preliminary drying at 80° C. for 20 minutes, and subjected to firing at 450° C. for 1 hour. Through this step, a 5 μm-thick porous insulating layer 4 was formed on the photoelectric conversion layer 3.

### (Formation of Catalyst Layer)

An electron beam vapor deposition apparatus EVD-500A (manufactured by ANELVA) was used to vapor-deposit platinum at a vapor deposition rate of 0.1 Å/s to form a catalyst layer 5 made of a 5 nm-thick platinum film on the porous insulating layer 4.

### (Formation of Second Conductive Layer)

An electron beam vapor deposition apparatus EVD-500A (manufactured by ANELVA) was used to vapor-deposit titanium (Ti) at a vapor deposition rate of 0.1 Å/s to form a second conductive layer 6 made of a 2 μm-thick Ti film on the catalyst layer 5.

### (Preparation of Electrolytic Solution)

A redox electrolytic solution was prepared. Specifically, 0.6 mol/L of 1,2-dimethyl-3-propylimidazolium iodide (manufactured by SHIKOKU CHEMICALS CORPORATION), 0.1 mol/L of LiI (manufactured by Aldrich Chemical Company), 0.5 mol/L of 4-tert-butylpyridine (manufactured by Aldrich Chemical Company), and 0.01 mol/L of I₂ (manufactured by TOKYO CHEMICAL INDUSTRY Co., Ltd.) were dissolved in acetonitrile used as a solvent.

(Sealing with Sealing Material)

An ultraviolet-curable material 31X-101 (manufactured by ThreeBond Co., Ltd.) serving as the sealing material 8 was applied to a cover material 9 formed of a glass substrate (Corning 7059) having a surface with dimensions of 110 mm width×(4Y+10) mm length, and the glass substrate with the SnO₂ film was laminated to the cover material 9. Then portions to which the ultraviolet curing agent was applied were irradiated with ultraviolet rays using an ultraviolet irradiation lamp Novacure (manufactured by EFD) to cure the sealing material 8, and the glass substrate serving as the substrate 1 was thereby fixed to the cover material 9 through the sealing material 8.

### (Pouring of Electrolytic Solution)

The above-prepared redox electrolytic solution was poured into spaces between the substrate 1 and the cover material 9 and surrounded by the sealing material 8 from electrolytic solution-pouring holes formed in advance in the cover material 9. In this manner, the photoelectric conversion module in Example 1 was produced, in which a plurality of photoelectric conversion cells 10 having a unit cell length X of 10 cm and a unit cell width Y of 0.5 cm were connected in series.

### Example 2

A photoelectric conversion module in Example 2 was produced in the same manner as in Example 1 except that the unit cell width Y was changed to 1 cm.

### Example 3

A photoelectric conversion module in Example 3 was produced in the same manner as in Example 1 except that the unit cell width Y was changed to 1.5 cm.

### Example 4

A photoelectric conversion module in Example 4 was produced in the same manner as in Example 1 except that the unit cell width Y was changed to 2 cm.

### Example 5

A photoelectric conversion module in Example 5 was produced in the same manner as in Example 1 except that the unit cell width Y was changed to 2.5 cm.

### Example 6

A photoelectric conversion module in Example 6 was produced in the same manner as in Example 1 except that the unit cell width Y was changed to 3 cm.

### Example 7

A photoelectric conversion module in Example 7 was produced in the same manner as in Example 1 except that the unit cell width Y was changed to 3.5 cm.

### Example 8

A photoelectric conversion module in Example 8 was produced in the same manner as in Example 1 except that the unit cell width Y was changed to 4 cm.

### Example 9

A photoelectric conversion module in Example 9 was produced in the same manner as in Example 1 except that the unit cell width Y was changed to 4.5 cm.

### Example 10

A photoelectric conversion module in Example 10 was produced in the same manner as in Example 1 except that the unit cell width Y was changed to 5 cm.

### Example 11

A photoelectric conversion module in Example 11 was produced in the same manner as in Example 1 except that the unit cell width Y was changed to 5.5 cm.

### Example 12

A photoelectric conversion module in Example 12 was produced in the same manner as in Example 1 except that the unit cell width Y was changed to 6 cm.

### Example 13

A photoelectric conversion module in Example 13 was produced in the same manner as in Example 1 except that the unit cell width Y was changed to 6.5 cm.

### Example 14

A photoelectric conversion module in Example 14 was produced in the same manner as in Example 1 except that the unit cell width Y was changed to 7 cm.

### Example 15

A photoelectric conversion module in Example 15 was produced in the same manner as in Example 1 except that the unit cell width Y was changed to 7.5 cm.

### Comparative Example 1

A photoelectric conversion module in Comparative Example 1 was produced in the same manner as in Example 1 except that the unit cell width Y was changed to 8 cm.

### Comparative Example 2

A photoelectric conversion module in Comparative Example 2 was produced in the same manner as in Example 1 except that the unit cell width Y was changed to 8.5 cm.

### Comparative Example 3

A photoelectric conversion module in Comparative Example 3 was produced in the same manner as in Example 1 except that the unit cell width Y was changed to 9 cm.

### Comparative Example 4

A photoelectric conversion module in Comparative Example 4 was produced in the same manner as in Example 1 except that the unit cell width Y was changed to 9.5 cm.

### Comparative Example 5

A photoelectric conversion module in Comparative Example 5 was produced in the same manner as in Example 1 except that the unit cell width Y was changed to 10 cm.

### Comparative Example 6

A photoelectric conversion module in Comparative Example 6 was produced in the same manner as in Example 2 except that nine linear gird electrodes formed from a Ti film and each having a width of 0.4 mm and a thickness of 2 μm were provided in advance on the SnO₂ film at intervals of 9.6 mm and then the porous semiconductor layer 3a was formed. The grid electrodes were formed in the same manner as the second conductive layer 6.

### Comparative Example 7

A photoelectric conversion module in Comparative Example 7 was produced in the same manner as in Comparative Example 6 except that the unit cell width Y was changed to 2 cm.

### Comparative Example 8

A photoelectric conversion module in Comparative Example 8 was produced in the same manner as in Comparative Example 6 except that the unit cell width Y was changed to 3 cm.

### Comparative Example 9

A photoelectric conversion module in Comparative Example 9 was produced in the same manner as in Comparative Example 6 except that the unit cell width Y was changed to 4 cm.

### <Evaluation>

Each of the above-produced photoelectric conversion modules in Examples 1 to 15 and Comparative Examples 1 to 9 was irradiated with light with an energy density of 1 mW/cm² (an AM1.5 solar simulator, dimmed by an ND filter) to measure a conversion efficiency [%].

The conversion efficiency [%] of each of the photoelectric conversion modules in Examples 1 to 15 and Comparative Examples 1 to 9 was determined by dividing the short-circuit current by the area of an aperture region (a region surrounded by a frame obtained by connecting outer frames of the plurality of photoelectric conversion cells 10 of the photoelectric conversion module) and then multiplying the quotient by an open-circuit voltage Voc [V] and a FF. In the example shown in FIG. 1, the aperture region is a rectangular region with points A, B, C, and D as vertices.

The voltage drop E [V] of a unit cell in each of the photoelectric conversion modules in Examples 1 to 15 and Comparative Examples 1 to 9 was determined using formula (G1) below. In formula (G1) below, R₃ means the total sheet resistance [Ω/square] of the SnO₂ film serving as the second conductive layer 2 and the Ti film serving as the second conductive layer 6.

E[V]=Pᵢₙ×Rₛ×Y²×10⁻⁴ (G1)

The light-receiving area fraction [%] of each of the photoelectric conversion modules in Examples 1 to 15 and Comparative Examples 1 to 9 was determined using formula (IV) below. In formula (IV) below, the area of a power generation layer of the photoelectric conversion module is used. In the example shown in FIG. 1, this area is the total of the projected areas of the light-receiving surfaces of the four sections of the photoelectric conversion layer 3 on a plane parallel to the light-receiving surface.

Light-receiving area fraction [%]=100×(area of power generation layer of photoelectric conversion module)/(area of aperture region of photoelectric conversion module) (IV)

Table 1 shows the unit cell length X [cm], the unit cell width Y [cm], the short-circuit current I_{sc} [mA] of a unit cell, I_{sc}/X [mA/cm], the voltage drop E [V] of the unit cell, the conversion efficiency [%], the light-receiving area fraction [%], and the short-circuit current density J_{sc} [mA/cm²] of the unit cell obtained by irradiation with pseudo sunlight with an energy density of 100 mW/cm² (an AM1.5 solar simulator) (J_{sc} [mA/cm²] at 1 sun) for each of the photoelectric conversion modules in Examples 1 to 15 and Comparative Examples 1 to 9.

TABLE 1

| | Unit cell | Unit cell | | Short circuit | | | Light-receiving | Conversion |
|---|---|---|---|---|---|---|---|---|
| | length X | width Y | J_{SC} at 1 sun | current I_{SC} | I_{SC}/X | Voltage drop E | area fraction | efficiency |
| | [cm] | [cm] | [mA/cm²] | [mA] | [mA/cm] | [V] | [%] | [%] |
| Example 1 | 10 | 0.5 | 20.1 | 1 | 0.10 | 0.0003 | 86.96 | 7.86 |
| Example 2 | 10 | 1 | 20.0 | 2 | 0.20 | 0.0012 | 93.02 | 8.39 |
| Example 3 | 10 | 1.5 | 20.2 | 3 | 0.30 | 0.0026 | 95.24 | 8.57 |
| Example 4 | 10 | 2 | 20.1 | 4 | 0.40 | 0.0046 | 96.39 | 8.64 |
| Example 5 | 10 | 2.5 | 20.1 | 5 | 0.50 | 0.0072 | 97.09 | 8.66 |
| Example 6 | 10 | 3 | 20.2 | 6 | 0.60 | 0.0104 | 97.56 | 8.65 |
| Example 7 | 10 | 3.5 | 20.1 | 7 | 0.70 | 0.0141 | 97.90 | 8.62 |
| Example 8 | 10 | 4 | 20.0 | 8 | 0.80 | 0.0184 | 98.16 | 8.57 |
| Example 9 | 10 | 4.5 | 20.1 | 9 | 0.90 | 0.0233 | 98.36 | 8.50 |
| Example 10 | 10 | 5 | 20.1 | 10 | 1.00 | 0.0288 | 98.52 | 8.42 |
| Example 11 | 10 | 5.5 | 20.0 | 11 | 1.10 | 0.0348 | 98.65 | 8.33 |
| Example 12 | 10 | 6 | 20.1 | 12 | 1.20 | 0.0414 | 98.77 | 8.23 |
| Example 13 | 10 | 6.5 | 20.2 | 13 | 1.30 | 0.0486 | 98.86 | 8.12 |
| Example 14 | 10 | 7 | 20.1 | 14 | 1.40 | 0.0564 | 98.94 | 7.99 |
| Example 15 | 10 | 7.5 | 20.1 | 15 | 1.50 | 0.0647 | 99.01 | 7.86 |
| Comparative Example 1 | 10 | 8 | 20.2 | 16 | 1.60 | 0.0736 | 99.07 | 7.71 |
| Comparative Example 2 | 10 | 8.5 | 20.2 | 17 | 1.70 | 0.0831 | 99.13 | 7.55 |
| Comparative Example 3 | 10 | 9 | 20.1 | 18 | 1.80 | 0.0932 | 99.17 | 7.39 |
| Comparative Example 4 | 10 | 9.5 | 20.0 | 19 | 1.90 | 0.1038 | 99.22 | 7.21 |
| Comparative Example 5 | 10 | 10 | 20.1 | 20 | 2.00 | 0.1150 | 99.26 | 7.02 |
| Comparative Example 6 | 10 | 1 | 20.1 | 1.93 | 0.19 | 0.0003 | 89.67 | 8.10 |
| Comparative Example 7 | 10 | 2 | 20.0 | 3.86 | 0.39 | 0.0012 | 92.92 | 8.38 |
| Comparative Example 8 | 10 | 3 | 20.2 | 5.78 | 0.58 | 0.0027 | 94.05 | 8.46 |
| Comparative Example 9 | 10 | 4 | 20.1 | 7.71 | 0.77 | 0.0048 | 94.63 | 8.48 |

As shown in Table 1, in the photoelectric conversion modules in Examples 1 to 15 and Comparative Examples 1 to 9, the short-circuit current density J_{sc} [mA/cm²] of a unit cell during irradiation with pseudo sunlight with an energy density of 100 mW/cm² (the AM1.5 solar simulator) was 20 [mA/cm²] or more, and I_{sc}/X [mA/cm] was 2 [mA/cm] or less. As the unit cell width Y increased, the light-receiving area fraction increased, and the conversion efficiency increased, but, at the same time, the voltage drop increased. Therefore, the conversion efficiency started decreasing when the Y exceeded a certain value. As shown in Table 1, in the photoelectric conversion modules in Examples 1 to 15 in which the unit cell width Y was from 0.5 cm to 7.5 cm inclusive, the voltage drop was less than 0.07 V, which was lower than that in the photoelectric conversion modules in Comparative Examples 1 to 5 in which the unit cell width Y was more than 8 mm. Therefore, because of the tradeoff described above, a high conversion efficiency of 7.86 [%] or more was obtained in the photoelectric conversion modules in Examples 1 to 15.

In the photoelectric conversion modules in Examples 10 to 15, although their conversion efficiency was equivalent to that in Example 1, the short-circuit current I_{sc} was higher by a factor of 10 to 15. Therefore, although the photoelectric conversion modules in Examples 1 to 9 can be preferably used as power sources of electronic devices used indoors under low illuminance, the photoelectric conversion modules in Examples 10 to 15 may be particularly preferably used under low illuminance.

In the photoelectric conversion modules in Examples 2, 4, 6, and 8, no gird electrodes were provided, so that the voltage drop of the unit cell was larger than that in the photoelectric conversion modules in Comparative Examples 6 to 9 having the same structure as in Examples 2, 4, 6, and 8 except that the grid electrodes were provided. However, in the photoelectric conversion modules in Examples 2, 4, 6, and 8, since their light-receiving area fraction is larger than that in the photoelectric conversion modules in Comparative Examples 6 to 9, the amount of increase in the short-circuit current of the unit cell due to the increase in the light-receiving area fraction may be larger than the reduction in FF caused by the increase in voltage drop of the unit cell due to the grid electrodes installed. This may be the reason of the increase in the overall conversion efficiency of the photoelectric conversion module in each of Examples 2, 4, 6, and 8.

As can be seen from the above results, in the photoelectric conversion modules in Examples 1 to 15, the conversion efficiency can be improved without grid electrodes disposed on the light-receiving surface. The photoelectric conversion modules are usable under low illuminance.

### Experimental Example 2

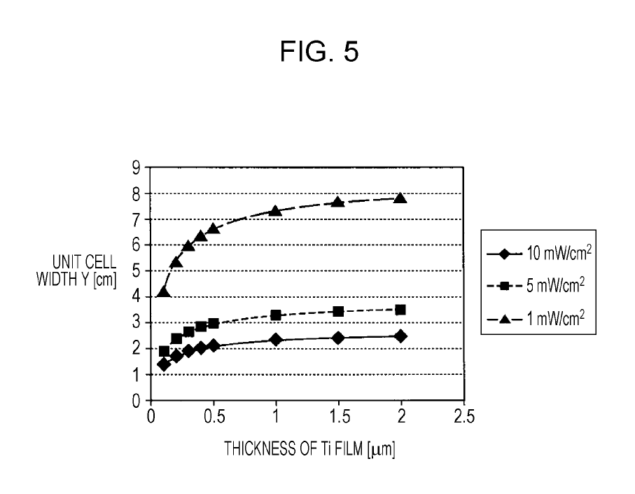

Photoelectric conversion modules having the structure shown in FIGS. 1 and 2 were produced using a Ti film as the second conductive layer 6. The photoelectric conversion modules had different Ti layer thicknesses of 0.1 μm, 0.2 μm, 0.3 μm, 0.4 μm, 0.5 μm, 1.0 μm, 1.5 μm, and 2.0 μmu, and the sheet resistance of each of the Ti films formed in the photoelectric conversion modules was measured. The values of the unit cell width Y [cm] obtained by substituting Rₛ [Ω/square] determined by the sheet resistance measurement at different Ti film thicknesses and the intensity Pᵢₙ of incident light (1 [mW/cm²], 5[mW/cm²], or 10 [mW/cm²]) into formula (H) above were plotted. The results are shown in FIG. 5. In FIG. 5, the horizontal axis represents the thickness [μm] of the Ti film, and the vertical axis represents the unit cell width Y [cm].

The unit cell width Y of a photoelectric conversion module at which the voltage drop of the unit cell can be reduced to suppress the reduction in FF and a maximum short-circuit current I_{sc} can be obtained can be determined from the results shown in FIG. 5.

In a conventional photoelectric conversion module for high illuminance (100 mW/cm²), the thickness of the second conductive layer 6 formed from a Ti film must be about 2 μm in order to suppress the voltage drop. However, as can be seen from the results shown in FIG. 5, even when the thickness of the second conductive layer 6 formed from a Ti film was 1 μm, the short-circuit current and voltage drop of the unit cell could be maintained without reducing the unit cell width Y. The above results show that the thickness of the Ti film can be reduced to half while the short-circuit current I_{sc} of the unit cell and the FF of the photoelectric conversion module are maintained. In addition, since the reduction in the thickness of the Ti film allows delamination of the Ti film to be suppressed, the yield of the photoelectric conversion module can be improved.

### Experimental Example 3

Photoelectric conversion modules in Examples 16 to 21 were produced. Specifically, in these photoelectric conversion modules, the size of the unit cell was the same as that of the unit cell in Example 11, but their second conductive layers 6 were formed from Ti films with different thicknesses.

### Example 16

The photoelectric conversion module in Example 16 was produced in the same manner as in Example 11 except that the thickness of the second conductive layer 6 formed from the Ti film was changed to 1.5 μm.

### Example 17

The photoelectric conversion module in Example 17 was produced in the same manner as in Example 11 except that the thickness of the second conductive layer 6 formed from the Ti film was changed to 1.0 m.

### Example 18

The photoelectric conversion module in Example 18 was produced in the same manner as in Example 11 except that the thickness of the second conductive layer 6 formed from the Ti film was changed to 0.5 μm.

### Example 19

The photoelectric conversion module in Example 19 was produced in the same manner as in Example 11 except that the thickness of the second conductive layer 6 formed from the Ti film was changed to 0.3 μm.

### Example 20

The photoelectric conversion module in Example 20 was produced in the same manner as in Example 11 except that the thickness of the second conductive layer 6 formed from the Ti film was changed to 0.2 μm.

### Example 21

The photoelectric conversion module in Example 21 was produced in the same manner as in Example 11 except that the thickness of the second conductive layer 6 formed from the Ti film was changed to 0.1 μm.

### <Evaluation>

The sheet resistance [Ω/square] of the surface of the second conductive layer 6 formed from the Ti film in a unit cell of each of the above-produced photoelectric conversion modules in Examples 16 to 21 and Example 11 was measured. In addition, each of the above-produced photoelectric conversion modules in Examples 16 to 21 was irradiated with light with an energy density of 1 mW/cm² (an AM1.5 solar simulator, dimmed by an ND filter) to determine the conversion efficiency [%] in the same manner as for the photoelectric conversion module in Example 11. Moreover, the voltage drop E [V] of the unit cell of each of the photoelectric conversion modules in Examples 16 to 21 was computed in the same manner as for the photoelectric conversion module in Example 11.

Table 2 shows the thickness [μm] of the Ti film serving as the second conductive layer 6 in the unit cell, the sheet resistance [Ω/square] of the surface of the Ti film serving as the second conductive layer 6 in the unit cell, the voltage drop E [V] of the unit cell, and the conversion efficiency [%] for each of the photoelectric conversion modules in Examples 16 to 21. The values of the photoelectric conversion module in Example 11 are also shown in Table 2.

TABLE 2

| | Thickness | Sheet | Voltage | Conversion |
|---|---|---|---|---|
| | of Ti film | resistance | drop E | efficiency |
| | [μm] | [Ω/square] | [V] | [%] |
| Example 11 | 2.0 | 11.5 | 0.0348 | 8.33 |
| Example 16 | 1.5 | 12 | 0.0363 | 8.31 |
| Example 17 | 1.0 | 13 | 0.0393 | 8.26 |
| Example 18 | 0.5 | 16 | 0.0484 | 8.10 |
| Example 19 | 0.3 | 20 | 0.0605 | 7.90 |
| Example 20 | 0.2 | 25 | 0.0756 | 7.64 |
| Example 21 | 0.1 | 40 | 0.1210 | 6.88 |

As can be seen in Table 2, in the photoelectric conversion modules in Examples 16 to 20 in which the thickness of the second conductive layer 6 formed from the Ti film in a unit cell was from 0.3 μm to 2 μm inclusive, the conversion efficiency [%] was higher than that of the photoelectric conversion module in Example 1.

In the photoelectric conversion modules in Examples 17 to 21 in which the thickness of the second conductive layer 6 formed from the Ti film in a unit cell was 1 μm or less, delamination of, particularly, the second conductive layer 6 was not found, and the photoelectric conversion module could be produced with high yield.

### [Additional Remarks]

(1) The first aspect of the present invention can provide a photoelectric conversion module including a substrate and a plurality of photoelectric conversion cells connected in series on the substrate. Each of the photoelectric conversion cells includes a first conductive layer, a second conductive layer facing the first conductive layer with a spacing therebetween, a photoelectric conversion layer on the first conductive layer, and a carrier-transport material between the first conductive layer and the second conductive layer. The photoelectric conversion layer includes a porous semiconductor layer and a photosensitizer on the porous semiconductor layer. A short-circuit current density J_{sc} obtained by irradiating the photoelectric conversion cells with pseudo sunlight with an energy density of 100 mW/cm² satisfies the relation of formula (I) (J_{sc}≧20 mA/cm²). A short-circuit current I_{sc} obtained by irradiating the photoelectric conversion cells with pseudo sunlight with an energy density of 1 mW/cm² and the length X of the porous semiconductor layer in a direction perpendicular to the series connection direction of the photoelectric conversion cells satisfy the relation of formula (II) (I_{sc}/X≦2 mA/cm). The intensity Pᵢₙ [mW/cm²] of light incident on the photoelectric conversion module, the total sheet resistance Rₛ [Ω/square] of the first conductive layer and the second conductive layer in the photoelectric conversion cells, and the length Y [cm] of the porous semiconductor layer in the series connection direction of the photoelectric conversion cells satisfy the relation of formula (III) (Pᵢₙ×Rₛ×Y²×10⁻⁴<0.07). With this structure, the photoelectric conversion module has high conversion efficiency without grid electrodes disposed on the light-receiving surface and can be used under low illuminance. Since it is unnecessary to provide grid electrodes, the light-receiving area fraction can be increased, and the cost of the material of the grid electrodes and their installation cost can be reduced. Since the relation I_{sc}/X≦2 mA/cm holds, deterioration in the characteristics of the photoelectric conversion module can be suppressed even when the unit cell width Y is increased.

(2) In the photoelectric conversion module according to the first aspect of the present invention, it is preferable that the second conductive layer contains titanium and that the second conductive layer has a thickness of from 0.3 μm to 2 μm inclusive. When the thickness of the second conductive layer containing Ti is 0.3 μm or more, the conversion efficiency of the photoelectric conversion module can be high even under low illuminance with, for example, an energy density of 1 mW/cm². When the thickness of the second conductive layer containing Ti is 2 μm or less, the effect of suppressing delamination of the second conductive layer can be improved, so that the yield of the photoelectric conversion module can be improved.

(3) In the photoelectric conversion module according to the first aspect of the present invention, it is preferable that the Rₛ is 20 Ω/square or less. When the total sheet resistance Rₛ of the first and second conductive layers in a unit cell is 20 [Ω/square] or less, the reduction in FF due to the voltage drop of the unit cell is suppressed, whereby the overall conversion efficiency of the photoelectric conversion module can be improved.

(4) In the photoelectric conversion module according to the first aspect of the present invention, it is preferable that the Y is from 0.5 cm to 7.5 cm inclusive. Also in this case, the photoelectric conversion module has high conversion efficiency without grid electrodes disposed on the light-receiving surface and can be used under low illuminance.

(5) The second aspect of the present invention can provide an electronic device that includes, as a power source unit, the photoelectric conversion module according to the first aspect of the present invention. Since the electronic device according to the second aspect of the present invention includes, as a power source unit, the photoelectric conversion module according to the first aspect of the present invention, the electronic device can be used even under low illuminance.

The embodiment and Examples of the present invention have been described. It is originally intended that some features of the embodiment and Examples may be combined appropriately.

It should be understood that the embodiment disclosed herein is illustrative and nonrestrictive in every respect. The scope of the present invention is defined not by the preceding description but instead by the scope of the claims and is intended to include any modifications within the scope of the claims and meaning equivalent to the scope of the claims.

### INDUSTRIAL APPLICABILITY

The photoelectric conversion module in the embodiment, which is an example of the present invention, can be particularly preferably used as a dye-sensitized solar cell module and used for electronic devices (e.g., various sensors such as indoor person detecting sensors and temperature sensors) each including the dye-sensitized solar cell module as a power source unit.

### REFERENCE SIGNS LIST

1: substrate, 2: first conductive layer, 3: photoelectric conversion layer, 3a: porous semiconductor layer, 4: porous insulating layer, 5: catalyst layer, 6: second conductive layer, 7: carrier-transport material, 8: sealing material, 9: cover material, 10: photoelectric conversion cell

1. A photoelectric conversion module comprising
a substrate and
a plurality of photoelectric conversion cells connected in series on the substrate,
wherein each of the photoelectric conversion cells includes
a first conductive layer,
a second conductive layer facing the first conductive layer with a spacing therebetween,
a photoelectric conversion layer on the first conductive layer, and
a carrier-transport material between the first conductive layer and the second conductive layer,
wherein the photoelectric conversion layer includes a porous semiconductor layer and a photosensitizer absorbed to the porous semiconductor layer,
wherein a short-circuit current density J_{sc} obtained by irradiating the photoelectric conversion cells with pseudo sunlight with an energy density of 100 mW/cm² satisfies the relation of the following formula (I):
J_{sc}≧20 mA/cm² (I),
wherein a short-circuit current I_{sc} obtained by irradiating the photoelectric conversion cells with pseudo sunlight with an energy density of 1 mW/cm² and a length X of the porous semiconductor layer in a direction perpendicular to a series connection direction of the photoelectric conversion cells satisfy the relation of the following formula (II):
I_{sc}/X≦2 mA/cm (II), and
wherein an intensity Pᵢₙ [mW/cm²] of light incident on the photoelectric conversion module, a total sheet resistance Rₛ [Ω/square] of the first conductive layer and the second conductive layer in the photoelectric conversion cells, and a length Y [cm] of the porous semiconductor layer in the series connection direction of the photoelectric conversion cells satisfy the relation of the following formula (III):
Pᵢₙ×Rₛ×Y²×10⁻⁴<0.07. (III)

2. (canceled)

3. (canceled)

4. (canceled)

5. (canceled)

6. The photoelectric conversion module according to claim 1, wherein the second conductive layer contains at least one selected from the group consisting of titanium, tungsten, gold, silver, copper, aluminum, and nickel.

7. The photoelectric conversion module according to claim 1, wherein the second conductive layer has a thickness of from 0.02 μm to 5 μm inclusive.

8. The photoelectric conversion module according to claim 1, wherein the second conductive layer contains titanium, and
the second conductive layer has a thickness of from 0.3 μm to 2 μm inclusive.

9. The photoelectric conversion module according to claim 1, wherein the Rₛ is 20 Ω/square or less.

10. The photoelectric conversion module according to claim 1, wherein the Y is less than 8 cm.

11. The photoelectric conversion module according to claim 1, wherein the Y is from 0.5 cm to 7.5 cm inclusive.

12. The photoelectric conversion module according to claim 1, wherein the first conductive layer has a thickness of from 0.02 μm to 5 μm inclusive.

13. The photoelectric conversion module according to claim 1, wherein the porous semiconductor layer has a surface area of from 10 m²/g to 200 m²/g inclusive.

14. The photoelectric conversion module according to claim 1, further comprising a porous insulating layer disposed between the second conductive layer and the photoelectric conversion layer and placed on the photoelectric conversion layer.

15. The photoelectric conversion module according to claim 1, further comprising
a porous insulating layer on the photoelectric conversion layer and
a catalyst layer on the porous insulating layer,
wherein the second conductive layer is disposed on the catalyst layer.

16. An electronic device comprising, as a power source unit, the photoelectric conversion module according to claim 1.

17. A sensor comprising, as a power source unit, the photoelectric conversion module according to claim 1.
